(19) United States
(12) Patent Application Publication
(10) Pub. No.: US 2024/0025432 A1
(43) Pub. Date: Jan. 25, 2024

(54) DRIVER ASSISTANCE SYSTEM FOR VEHICLE

(71) Applicant: TOYOTA JIDOSHA KABUSHIKI KAISHA, Aichi-ken (JP)

(72) Inventors: Yudai SADAKUNI, Toyota-shi (JP); Masato ENDO, Nagoya-shi (JP); Yuko HIRATSUKA, Toyota-shi (JP); Akihito NAKAMURA, Toyota-shi (JP); Shuhei MANABE, Toyota-shi (JP)

(21) Appl. No.: 18/321,000

(22) Filed: May 22, 2023

(30) Foreign Application Priority Data
Jul. 25, 2022 (JP) 2022-117713

(51) Int. Cl. B60W 50/08; G06V 20/59; G06V 40/16; G06V 40/50

(52) U.S. Cl. CPC B60W 50/085; G06V 20/59; G06V 40/172; G06V 40/50; B60W 2540/215; B60W 2556/10; B60W 2420/42

(57) ABSTRACT

A personalization setting unit requests a new driver for setting whether to use a personalization function that is able to change a set value of a driver assistance function to a recommended value for each driver assistance function when the new driver is registered in a driver information registration unit.

### CROSS-REFERENCE TO RELATED APPLICATION

This application claims priority to Japanese Patent Application No. 2022-117713 filed on Jul. 25, 2022 incorporated herein by reference in its entirety.

### BACKGROUND

### 1. Technical Field

The present specification discloses a driver assistance system for a vehicle.

### 2. Description of Related Art

The driver assistance for a vehicle is classified into main categories of an information provision type assistance and an intervention operation type assistance. In the information provision type assistance, the operation to be performed by the driver is instructed through at least one of auditory information and visual information. For example, a display and speakers are provided around the driver's seat. Then, a message is displayed on the display and voice is output from the speaker.

In the intervention operation type assistance, the assistance system intervenes in steering, braking, and accelerator operations by the driver. For example, the steering column is provided with an actuator. In addition to the steering actuator, the system takes over the driving operation by transmitting control commands to a brake actuator, an inverter that controls a rotary electric machine serving as a drive source, and the like.

For example, in Japanese Unexamined Patent Application Publication No. 2018-49477 (JP 2018-49477 A), driving diagnosis is performed for the driving operation of the vehicle by the driver. Then, a driver assistance method that is customized for each driver is set based on a driving diagnostic result. For example, as items to be customized, the type of actuator to be intervened, control timing, control time, and control amount are set for each driver.

### SUMMARY

There are two modes of “customization” and “personalization” as modes for setting set values of various items of the driver assistance functions for each driver. In customization, the driver sets the set values based on preferences. In personalization, the driver assistance system selects optimal set values for each driver based on driving performance and the like.

With personalization settings, there is a possibility that driver assistance that is different from the feeling of the driver may be performed, and thus the driver may feel uncomfortable. Therefore, this specification discloses a driver assistance system for a vehicle that is capable of reducing a sense of discomfort of the driver as compared with a conventional system when the driver assistance based on the personalization function is performed.

A driver assistance system for a vehicle disclosed in this specification can perform a plurality of driver assistance functions with respect to the vehicle. A plurality of setting items is provided for each of the driver assistance functions. Further, a set value is defined for each of the setting items. The driver assistance system includes a driver information registration unit, a recommended value calculation unit, and a personalization setting unit. The driver information registration unit is able to register driver information. The recommended value calculation unit obtains a recommended value for the set value based on driving-related information of a driver including a driving history. The personalization setting unit requests a new driver for setting whether to use a personalization function that is able to change the set value of the driver assistance function to the recommended value for each of the driver assistance functions when the new driver is registered in the driver information registration unit.

According to the above configuration, at the time of registration of a new driver, the driver can set the driver assistance function for which personalization is desired and the driver assistance function for which personalization is not desired.

Also, in the above configuration, the personalization setting unit may determine whether the setting item to which the recommended value is set is an intervention operation type when making an approval necessity determination for sorting a plurality of the recommended values into an approval type recommended value requiring an approval of the driver and an automatic change type recommended value not requiring the approval of the driver.

According to the above configuration, it is possible to request the approval of the driver when the set value of the setting item for which the intervention operation to the vehicle is performed is changed. In the course of an approval process, the driver recognizes that the set value of the intervention operation involving vehicle motion is to be changed, whereby a sense of discomfort felt by the driver before and after the setting change can be reduced.

Also, in the above configuration, the personalization setting unit may determine whether a change to the recommended value reduces an intensity of driving assistance when making the approval necessity determination.

According to the above configuration, it is possible to avoid a situation in which the driver assistance intensity is reduced without the driver noticing.

Also, in the above configuration, the driver assistance system may include an imaging device and an image recognition unit. The imaging device includes a driver's seat in a field of view. The image recognition unit recognizes a face of the driver who is seated in the driver's seat based on an image captured by the imaging device. In this case, when the image recognition unit recognizes the new driver, the driver information registration unit requests the new driver for registering the driver information.

According to the above configuration, a new driver is encouraged for making registration.

Also, in the above configuration, the driver information registration unit may register an image of the face recognized by the image recognition unit as the driver information.

According to the above configuration, the set value corresponding to the driver can be called as long as the face image is recognized.

According to the driver assistance system for a vehicle of the present specification, a sense of discomfort of the driver can be reduced as compared with the conventional system when the driver assistance based on the personalization function is performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram exemplifying an overall configuration of a driver assistance system according to the present embodiment;

FIG. 2 is a diagram showing a hardware configuration of a vehicle;

FIG. 3 is a diagram exemplifying various sensors mounted in a front portion of the vehicle;

FIG. 4 is a diagram exemplifying a front portion of a vehicle cabin;

FIG. 5 is a diagram exemplifying hardware configurations of an OTA server, an ADAS-ECU, and an AV-ECU;

FIG. 6 is a diagram exemplifying functional blocks of the ADAS-ECU and the AV-ECU;

FIG. 7 is a diagram exemplifying a driver profile screen (initial screen);

FIG. 8 is a diagram exemplifying the driver profile screen (driver assistance function setting screen);

FIG. 9 is a diagram exemplifying a driver assistance function setting table;

FIG. 10 is a diagram exemplifying a driver assistance function recording table;

FIG. 11 is a diagram exemplifying a noted action table;

FIG. 12 is a diagram illustrating an approval necessity determination flow;

FIG. 13 is a diagram exemplifying a report screen when set values are changed to automatic change type recommended values;

FIG. 14 is a diagram exemplifying a detailed report screen describing setting items that are automatically changed;

FIG. 15 is a diagram exemplifying an approval screen when the set values are changed to approval type recommended values; and

FIG. 16 is a diagram exemplifying an approval detail screen when the set values are changed to approval type recommended values.

### DETAILED DESCRIPTION OF EMBODIMENTS

### System Overview

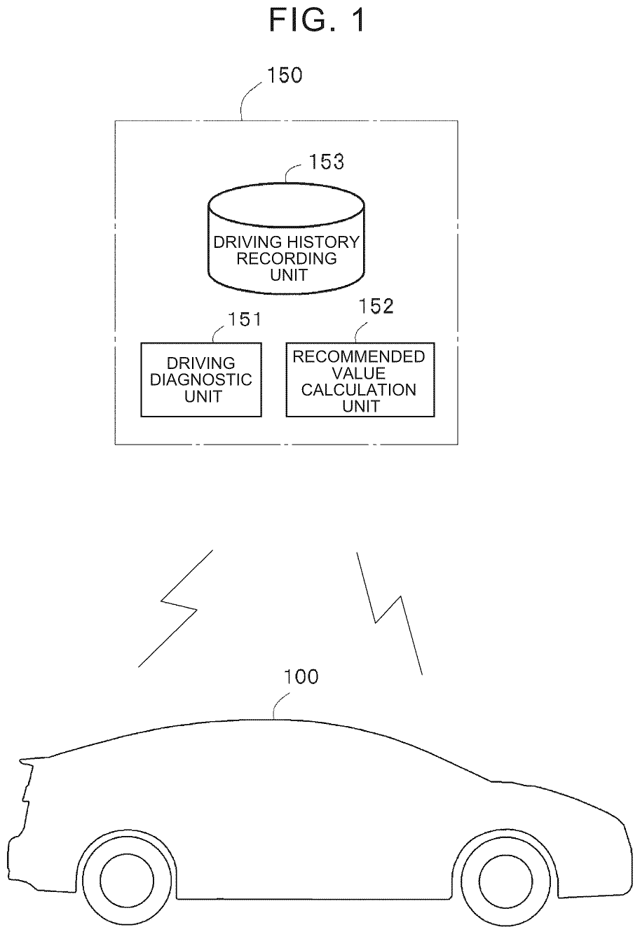

FIG. 1 exemplifies an overall configuration of a driver assistance system for a vehicle according to the present embodiment. This system includes a vehicle 100 and an over-the-air (OTA) center server 150.

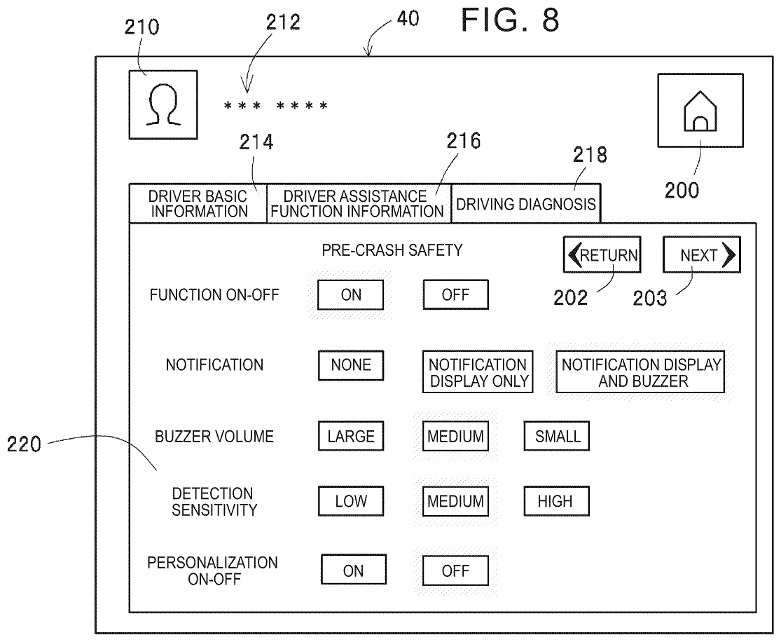

The vehicle 100 is capable of executing multiple types of driver assistance functions. Further, as shown in FIG. 8 to be described later, each driver assistance function (for example, pre-crash safety) is provided with a plurality of setting items (for example, function ON-OFF). A set value (for example, ON-OFF) is defined for each setting item.

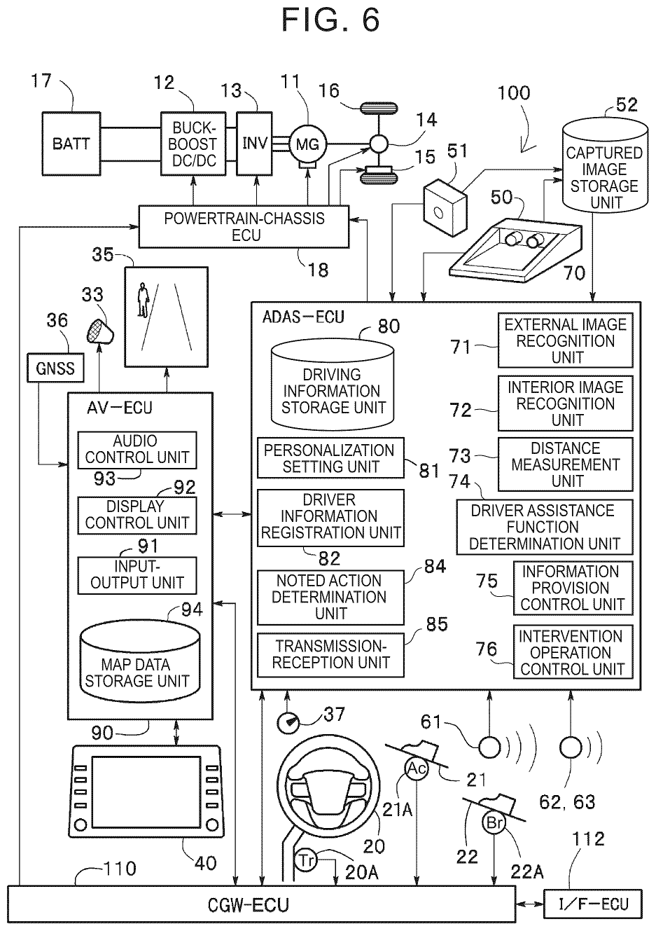

In addition, the vehicle 100 can set various settings of the driver assistance function for each driver. For this setting, driver information is registered in an ADAS-ECU (see FIG. 6). When the driver information is newly registered, setting of the driver assistance function is performed.

For setting the driver assistance function, on-off setting of a personalization function is performed as shown in FIG. 8 to be described later. With this on-off setting, it is possible to preliminarily exclude the driver assistance function that the driver does not request personalization from the targets of personalization.

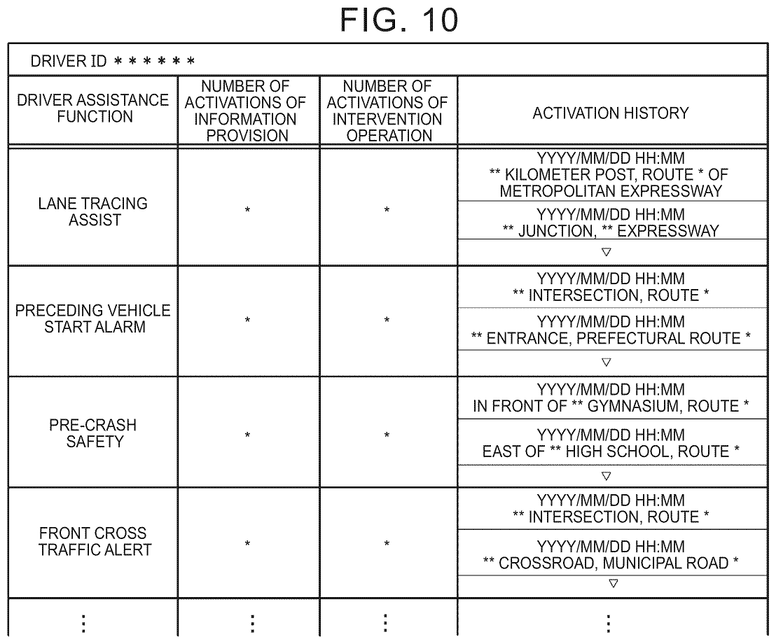

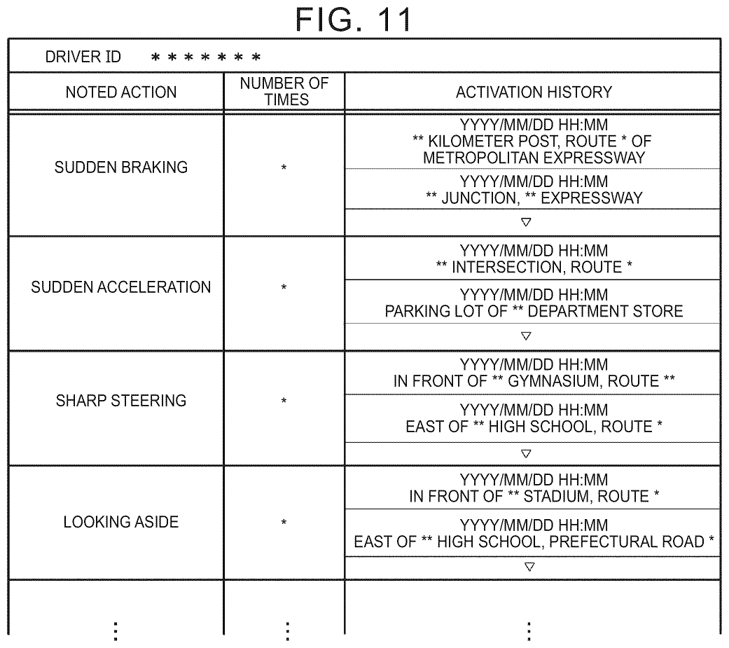

In order to provide personalization services, driving-related information including a driving history is transmitted from the vehicle 100 to the OTA center server 150 (see FIG. 1) for each driver. The driving-related information includes a driver assistance function recording table (see FIG. 10) and a noted action table (see FIG. 11) that will be described later.

The OTA center server 150 performs driving diagnosis based on the received driving-related information. Further, the OTA center server 150 calculates a recommended value with respect to the set value of the driver assistance function based on a diagnostic result. This recommended value is determined for each driver.

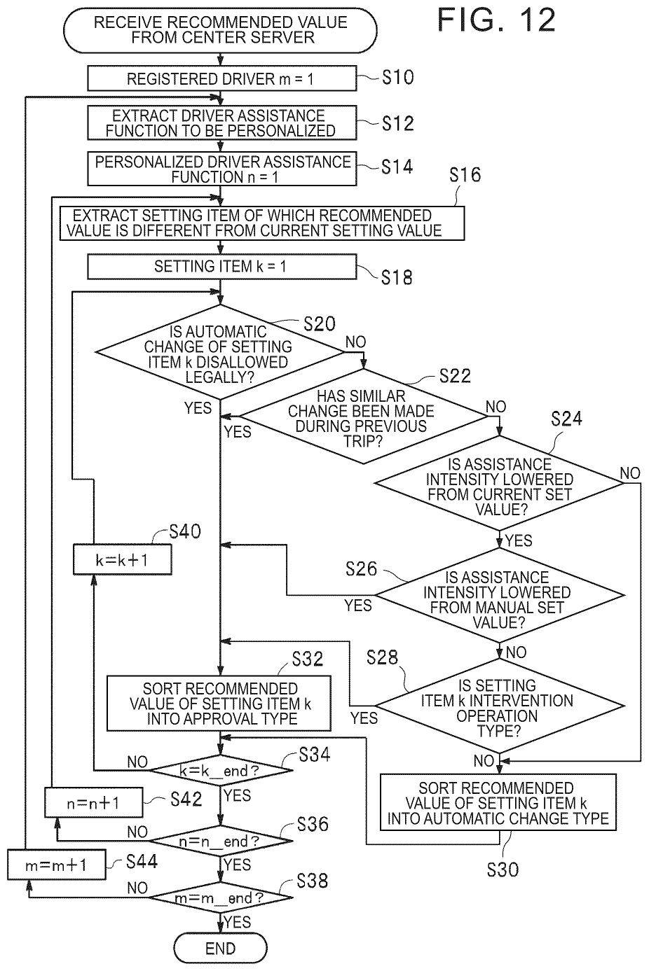

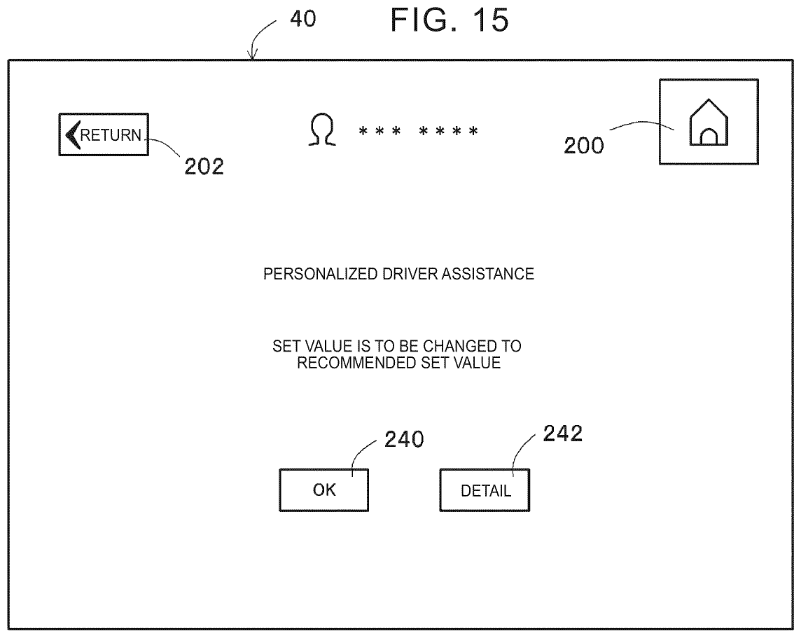

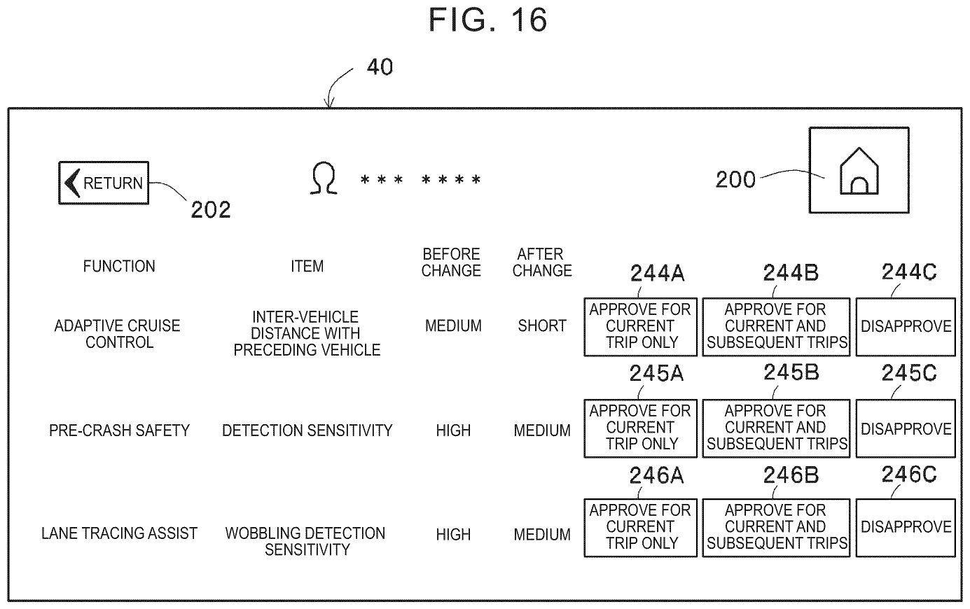

The vehicle 100 that has received the recommended values sorts the recommended values into an automatic change type (S30) and an approval type (S32) based on an approval necessity determination flow (see FIG. 12). The recommended values sorted into the automatic change type are set as set values for the driver assistance function with the approval of the driver omitted. On the other hand, the recommended values sorted into the approval type are set as set values for the driver assistance function after the approval of the driver as shown in FIGS. 15 and 16.

### Vehicle

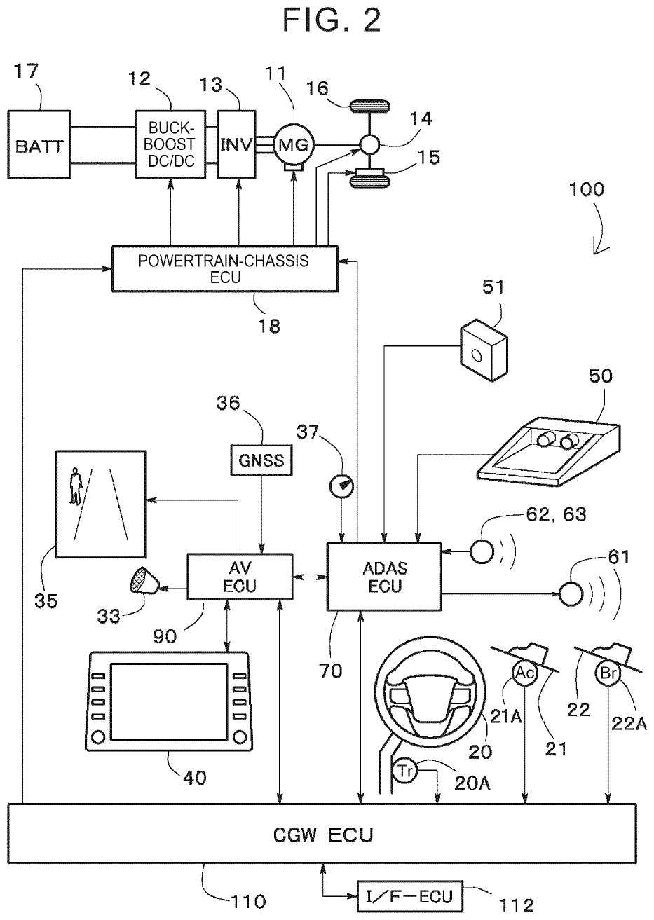

FIG. 2 exemplifies a hardware configuration of the vehicle 100. Note that FIG. 2 mainly exemplifies devices related to the driver assistance function of the vehicle 100, and the illustration of devices that are less relevant to the above function is omitted as appropriate.

The vehicle 100 may be, for example, a battery electric vehicle (BEV) that includes a rotary electric machine 11 as a drive source. Further, the vehicle 100 may be a hybrid electric vehicle (HEV) or a plug-in hybrid electric vehicle (PHEV).

### Drivetrain Devices

For example, the vehicle 100 includes a battery 17, a buck-boost DC/DC converter 12, an inverter 13, and the rotary electric machine 11 as drivetrain high-voltage circuits. The direct-current (DC) power output from the battery 17 is, for example, stepped up by the buck-boost DC/DC converter 12 and further converted into alternating current (AC) power by the inverter 13. The rotary electric machine 11 is driven by supplying the converted AC power to the rotary electric machine 11. The driving force is transmitted to wheels 16. Further, the wheels 16 are provided with a steering actuator 14 as a steering mechanism and a brake actuator 15 as a braking mechanism.

Further, the vehicle 100 is also provided with a steering wheel 20, an accelerator pedal 21, and a brake pedal 22 as mechanisms for manual operation. Further, the vehicle 100 is provided with a torque sensor 20A that detects an operation amount of the steering wheel 20. Still further, the vehicle 100 is provided with an accelerator position sensor 21A that detects the operation amount (depression amount) of the accelerator pedal 21 and a brake position sensor 22A that detects the operation amount (depression amount) of the brake pedal 22.

The operation amounts detected by the torque sensor 20A, the accelerator position sensor 21A, and the brake position sensor 22A are transmitted as electrical signals from the sensors 20A to 22A to a central gateway ECU 110 (hereinafter referred to as CGW-ECU as appropriate). In response to the above, the CGW-ECU 110 transmits a normal drive command, a normal braking command, and a normal steering command to a powertrain-chassis ECU 18.

Further, when an intervention operation type driver assistance function is executed, an intervention operation command is transmitted from the ADAS-ECU 70 to the powertrain-chassis ECU 18. For example, the intervention operation command has priority over the normal drive command, the normal braking command, and the normal steering command. The intervention operation command includes an intervention drive command, an intervention braking command, and an intervention steering command. Details of the driver assistance function will be described later.

The powertrain-chassis ECU 18 transmits a switching signal to the inverter 13 in accordance with the normal/intervention drive commands. The powertrain-chassis ECU 18 also transmits a drive signal to the motor of the brake actuator 15 in accordance with the normal/intervention braking commands. Further, the powertrain-chassis ECU 18 transmits drive signals to the steering actuator 14 in response to the normal/intervention steering commands.

### Sensors

FIG. 2 exemplifies sensors for enabling the driver assistance functions for the vehicle 100 to be executed. The vehicle 100 includes an exterior camera unit 50, a LiDAR sensor 61, and radar sensors 62, 63 as sensors for grasping the situation outside the vehicle.

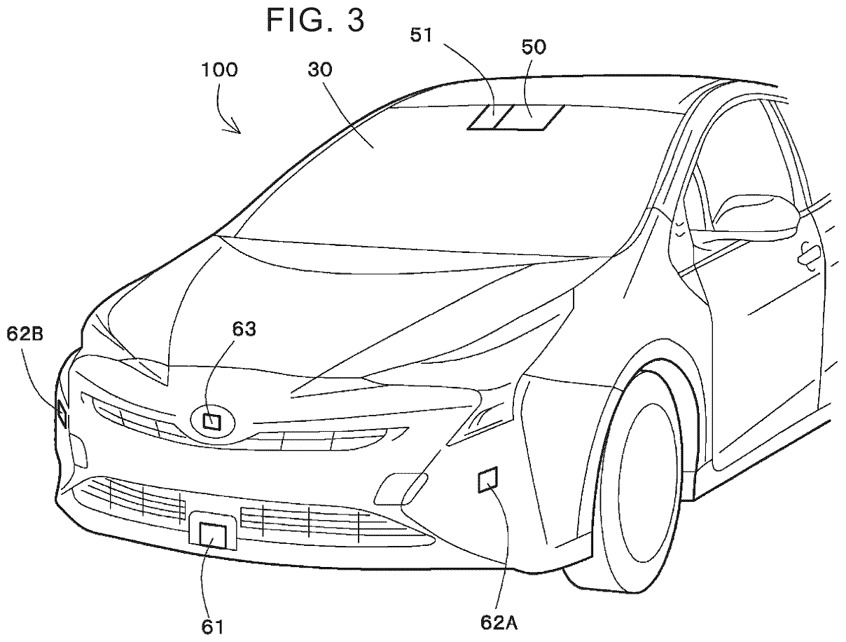

FIG. 3 exemplifies the front portion of the vehicle 100. A front center radar sensor 63 is provided on a front surface portion of the vehicle 100, for example, on the rear side of an emblem in the central portion in the vehicle width direction. Front side radar sensors 62A, 62B are provided on respective sides of the front surface of the vehicle 100. Both of the radar sensors are composed of millimeter wave radars, for example.

Furthermore, the LiDAR sensor 61 is provided on the front surface of the vehicle 100, for example, in the central portion in the vehicle width direction, below the license plate mounting position. The LiDAR (Light Detection and Ranging) sensor 61 planarly scans with laser light (for example, infrared rays) to measure the distance to surrounding objects. The LiDAR sensor 61 is, for example, a solid-state unit. Three dimensional point cloud data in front of the vehicle 100 can be obtained by the LiDAR sensor 61 planarly scanning forward of the vehicle 100 with a laser beam.

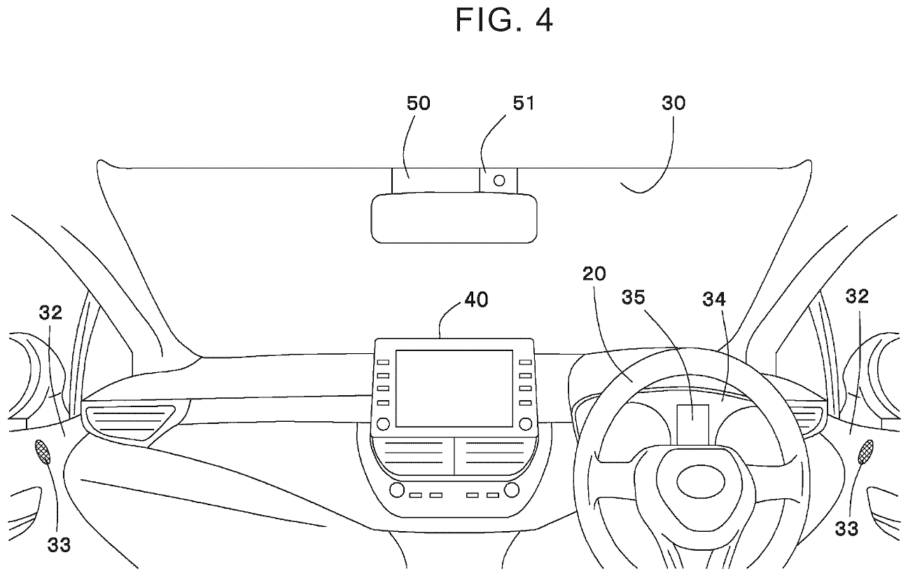

With reference to FIGS. 3 and 4, the exterior camera unit 50 and an interior camera 51 are provided on the rear surface of a windshield glass 30, that is, a surface exposed to a vehicle cabin. The exterior camera unit 50 and the interior camera 51 are provided, for example, in the center portion of the windshield glass 30 in the vehicle width direction and in an upper portion of the windshield glass 30.

The exterior camera unit 50 is, for example, a stereo camera unit (imaging device unit) composed of two cameras, and is capable of imaging the outside of the vehicle, more specifically, imaging forward of the vehicle through the windshield glass 30. The interior camera 51 is, for example, a monocular imaging device, and includes the driver's seat in a field of view of the imaging device. The interior camera 51 can capture the face of the driver who is seated in the driver's seat.

The exterior camera unit 50 and the interior camera 51 are each capable of capturing moving images. The captured moving image data is stored in a captured image storage unit 52 (see FIG. 6) in a state of being associated with the date and time when the image is captured.

With reference to FIG. 2, a self-position estimator 36 is, for example, a receiver of a global navigation positioning satellite system. The self-position estimator 36 is connected to an AV-ECU 90.

A clock 37 is connected to the ADAS-ECU 70. As will be described later, the driver assistance function determination unit 74 (see FIG. 6) of the ADAS-ECU 70 acquires the date and time when the driver assistance function is executed from the clock 37 and stores the date and time in a driving information storage unit 80. Further, a noted action determination unit 84 acquires the date and time at which the noted action of the driver occurs from the clock 37 and stores the date and time in the driving information storage unit 80.

### Audiovisual Devices

FIG. 4 illustrates the front portion of the vehicle cabin. As video devices, an instrument panel is provided with the center display 40 and a meter display 35.

The center display 40 is, for example, a touch panel display in which an input unit and a display unit are integrated. The center display 40 is installed, for example, at the center of the instrument panel in the vehicle width direction.

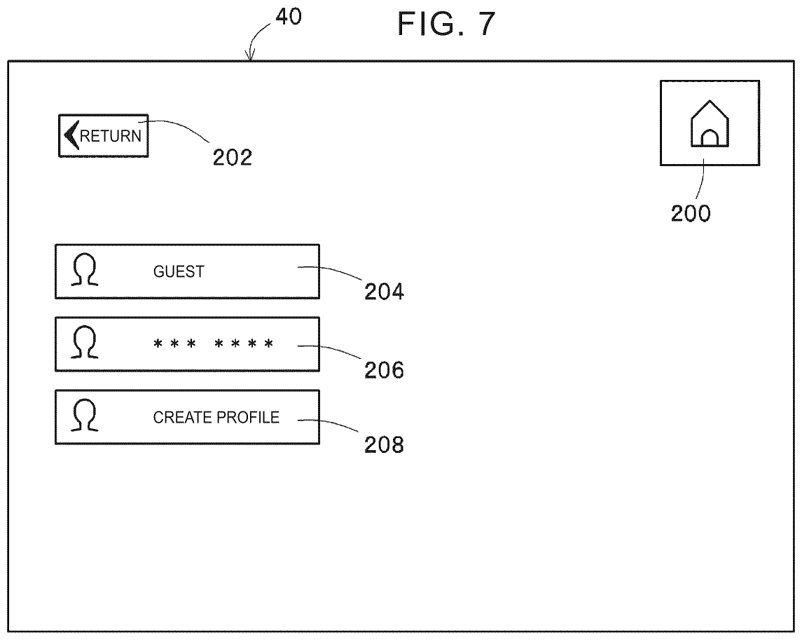

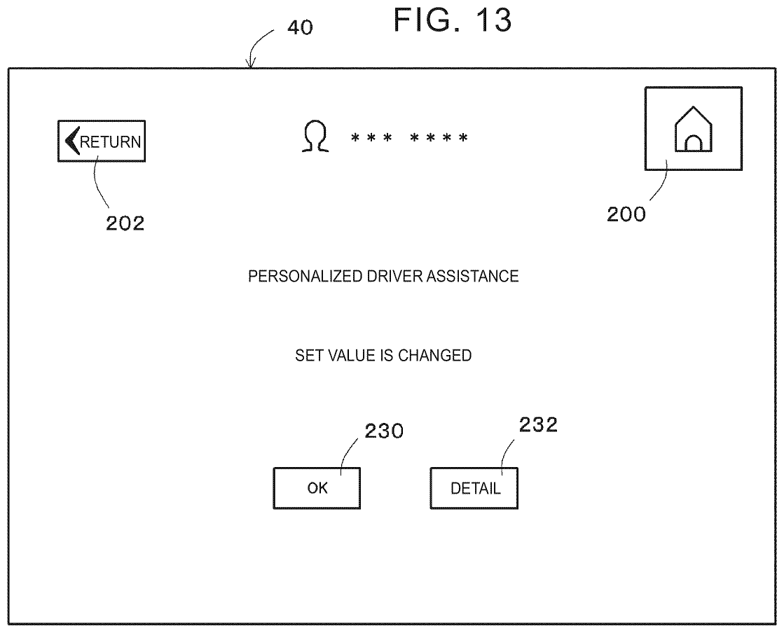

The center display 40 displays various types of information of the vehicle 100. For example, a navigation screen (not shown) showing a route to a destination is displayed on the center display 40. Furthermore, the center display 40 displays a driver profile screen exemplified in FIGS. 7 and 8 and a personalization setting screen exemplified in FIGS. 13 to 16.

With reference to FIG. 4, the meter display 35 is provided within an instrument cluster 34. The meter display 35 is disposed in front of the steering wheel 20, for example. For example, a notification message is displayed on the meter display 35 when an information provision type driver assistance function is executed.

Speakers 33 are provided in the vehicle cabin as an audio device. For example, the speakers 33 are provided in upper and forward portions of paired front doors 32, 32, respectively. Each speaker 33 is, for example, a so-called tweeter that outputs high-pitched sounds. Also, an output surface of each speaker 33 is directed toward the driver or an occupant seated in the passenger seat. As will be described later, a warning sound is output from the speakers 33 when the information provision type driver assistance function is executed.

### ECU

As exemplified in FIG. 2, the vehicle 100 is provided with a plurality of electronic control units (ECUs). These electronic control units are provided for each function of the vehicle 100, for example. For example, the vehicle 100 includes the powertrain-chassis ECU 18, the ADAS-ECU 70, the AV-ECU 90 and an I/F-ECU 112.

Further, the vehicle 100 is provided with a central gateway ECU 110 (CGW-ECU) as a master ECU that governs these functional ECUs. The CGW-ECU 110 governs each functional ECU, for example, when cooperative control in which multiple functional ECUs cooperate to execute one function is executed.

The powertrain-chassis ECU 18, the ADAS-ECU 70, the AV-ECU 90, and the OF-ECU 112 can communicate with each other via the CGW-ECU 110. Each ECU is connected by a signal line complying with the controller area network (CAN) standard, for example.

The powertrain-chassis ECU 18 controls the rotary electric machine 11, the steering actuator 14, and the brake actuator 15. Further, the OF-ECU 112 is an ECU serving as an interface for receiving signals from an external device such as the OTA center server 150 (see FIG. 1).

The ADAS-ECU 70 is an ECU for ADAS that denotes the advanced driver-assistance system. The ADAS-ECU 70 is connected via signals to the exterior camera unit the interior camera 51, the LiDAR sensor 61, and the radar sensors 62, 63 that are sensors for grasping conditions outside the vehicle.

The AV-ECU 90 executes display control and audio control of the speakers 33, the meter display 35, and the center display 40. The input operation information to the center display 40 that is a touch panel is transmitted from the AV-ECU 90 to the ADAS-ECU 70 and the CGW-ECU 110.

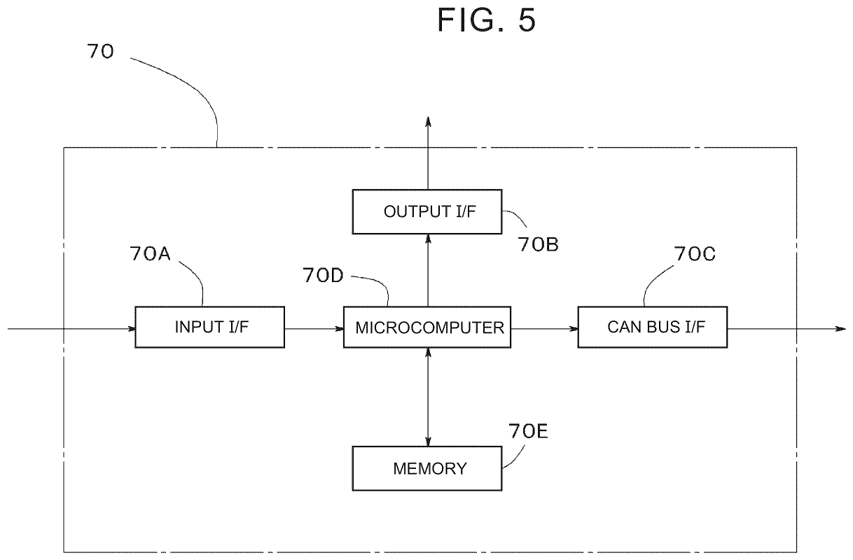

Both the functional ECUs and the CGW-ECU 110 described above are each composed of an electronic device (computer). FIG. 5 exemplifies the hardware configuration of the ADAS-ECU 70. The functional ECUs and the CGW-ECU 110 described above also have the same hardware configuration.

The ADAS-ECU 70 (other ECUs as well) includes an input OF 70A, an output OF 70B, a CAN bus OF 70C, a microcomputer 70D, and a memory 70E.

The CAN bus OF 70C is a device for connecting the ADAS-ECU 70 with other ECUs. The input OF 70A is a connection device for the ADAS-ECU 70 to receive a signal from an in-vehicle sensor device such as the exterior camera unit 50. The output OF 70B is a connection device for transmitting signals from the ADAS-ECU 70 to devices other than the ECUs.

The microcomputer 70D (microcomputer) executes various controls and calculations in accordance with a given program. For example, the microcomputer 70D includes peripheral devices such as a CPU, a memory, and an input-output device. Furthermore, the memory 70E that is a storage device such as a solid state drive (SSD) is connected to the microcomputer 70D.

### Functional Block of AV-ECU

A microcomputer executes a program stored in the memory of the AV-ECU to configure the functional blocks in the AV-ECU 90 as exemplified in FIG. 6. That is, the AV-ECU 90 includes an input-output unit 91, a display control unit 92, an audio control unit 93, and a map data storage unit 94.

The program may be stored in a non-transitory computer-readable storage medium such as a digital versatile disc (DVD), instead of storing the program in the memory, and the microcomputer may read and execute the program. Various functional blocks exemplified in FIG. 6 are configured in the AV-ECU 90 by such means as well.

The map data storage unit 94 stores map data associated with latitude and longitude information. The input-output unit 91 receives input signals from peripheral devices such as the ADAS-ECU 70. Further, the input-output unit 91 also receives input operation signals from the center display 40 that is a touch panel and transmits the signals to the peripheral devices such as the ADAS-ECU 70.

The audio control unit 93 controls the output of notification sounds included in the information provision type driver assistance function. For example, upon receipt of a notification command from an information provision control unit 75 of the ADAS-ECU 70, the audio control unit 93 causes the speakers 33 to output a notification sound.

The display control unit 92 controls display images of the meter display 35 and the center display 40. The display control unit 92 executes display control of notification messages included in the information provision type driver assistance function. For example, upon receipt of a notification command from the information provision control unit 75 of the ADAS-ECU 70, the display control unit 92 causes the meter display 35 to display a notification message text or a warning image (image of a pedestrian, etc.).

### Functional Block of ADAS-ECU

The microcomputer 70D (see FIG. 5) of the ADAS-ECU 70 executes a program stored in the memory 70E, thereby configuring the functional blocks in the ADAS-ECU 70 as exemplified in FIG. 6. That is, the ADAS-ECU 70 includes an exterior image recognition unit 71, an interior image recognition unit 72, a distance measurement unit 73, a driver assistance function determination unit 74, the information provision control unit 75, and an intervention operation control unit 76. The ADAS-ECU 70 further includes the driving information storage unit 80, a personalization setting unit 81, a driver information registration unit 82, the noted action determination unit 84, and a transmission-reception unit 85.

Note that, the program may be stored in a non-transitory computer-readable storage medium such as DVD, instead of storing the program in the memory 70E, and the microcomputer 70D may read and execute the program. Various functional blocks exemplified in FIG. 6 are configured in the ADAS-ECU 70 by such means as well.

The exterior image recognition unit 71 recognizes an image area of an object outside the vehicle from the image captured by the exterior camera unit 50. For example, the exterior image recognition unit 71 is implemented with a convolutional neural network (CNN) capable of executing the single shot multibox detector (SSD) using supervised learning as an image recognition algorithm. Attributes of various objects (vehicles, pedestrians, road signs, structures, etc.) included in the images captured by the exterior camera unit 50 are recognized through such image recognition.

Further, the distance measurement unit 73 acquires captured image data that has been subjected to image recognition from the exterior image recognition unit 71. Further, the distance measurement unit 73 also acquires three-dimensional point cloud data of distance measurement information from the LiDAR sensor 61. The distance measurement unit 73 obtains what kind of attributes an object has and how far the object is from the host vehicle by combining the three-dimensional point cloud data and the captured image data.

The interior image recognition unit 72 recognizes the face of the driver from the image captured by the interior camera 51 using the image recognition algorithm described above. The personalization setting unit 81 determines whether the driver corresponds to one of the registered drivers stored in the driving information storage unit 80 based on a face recognition result. Further, the noted action determination unit 84 determines whether the driver is performing a noted action, such as looking aside, based on the face recognition result.

The driver assistance function determination unit 74 determines whether to execute the driver assistance function with respect to the information provision control unit 75 and the intervention operation control unit 76 based on object information (the attributes and the distance from the host vehicle) around the host vehicle from the distance measurement unit 73.

As described above, the driver assistance functions are classified into main categories of an information provision type and an intervention operation type. For example, the information provision type driver assistance function is executed as a preliminary step before the intervention operation type driver assistance function is executed.

For example, when a pedestrian in front comes close in a predetermined first threshold distance, the driver assistance function determination unit 74 transmits a pedestrian approaching notification to the information provision control unit 75. The information provision control unit 75 transmits a pedestrian approaching warning command to the display control unit 92 and the audio control unit 93 of the AV-ECU 90. The display control unit 92 causes the meter display 35 to display the pedestrian image. Also, the audio control unit 93 causes the speakers 33 to output the notification sound.

When the distance to the pedestrian further decreases and the vehicle 100 approaches the pedestrian in a predetermined second threshold distance, the driver assistance function determination unit 74 outputs the intervention operation command to the intervention operation control unit 76. In response to the above, the intervention operation control unit 76 operates the brake actuator 15 via the powertrain-chassis ECU 18 to decelerate the vehicle 100, and also operates the steering actuator 14 such that the vehicle 100 moves close to the side opposite to the pedestrian in the lane in which the vehicle 100 is traveling.

The number of operations of the driver assistance function above is counted up. For example, FIG. 10 exemplifies the driver assistance function recording table. As exemplified in this table, after the driver assistance functions are sorted into the information provision type and the intervention operation type, the number of operations of each driver assistance function is counted up. In the driver assistance function recording table, the number of operations of each driver assistance function is recorded for each registered driver registered in the driver information registration unit 82.

In addition, this table also records data on the date and time when and a location where the driver assistance function is activated. The driver assistance function determination unit 74 acquires date and time data from the clock 37 (see FIG. 6). Further, the driver assistance function determination unit 74 also acquires location data from the self-position estimator 36. Further, with reference to the map data storage unit 94, the driver assistance function determination unit 74 extracts the name of the facility, intersection, or the like that is closest to the latitude and longitude of the vehicle 100 when the driver assistance function is activated, and records the extracted data in the driver assistance function recording table.

The noted action determination unit 84 determines whether a predetermined noted action among the driver actions has occurred in the vehicle 100. FIG. 11 exemplifies a noted action table. The noted action table is stored for each registered driver based on a personalization function to be described later. Noted action items are set in the noted action table.

The noted action refers to a driver action that increases the risk of a vehicle accident, and includes, for example, sudden braking, sudden acceleration, sharp steering, and looking aside. The sudden braking and the sudden acceleration denote states in which depressing accelerations of the brake pedal and the accelerator pedal exceed predetermined threshold values. The sharp steering refers to a state in which the angular acceleration when the steering wheel is turned exceeds a predetermined threshold value.

The noted action determination unit 84 determines whether noted actions of the sudden braking, sudden acceleration, and sharp steering occur based on the operation amounts detected by the brake position sensor 22A (see FIG. 6), the accelerator position sensor 21A, and the torque sensor 20A, respectively. Whether the driver looks aside can be determined from the captured image of the interior camera 51 as described above.

It is possible to determine with high accuracy whether the noted action occurs by determining whether there is a noted action based on the actual operation amounts detected by the brake position sensor 22A, the accelerator position sensor 21A, and the torque sensor 20A. For example, it is possible to determine with high accuracy whether the noted action occurs, as compared with determination based on images captured inside and outside the vehicle by the exterior camera unit 50, the interior camera 51, and the like.

For example, there may be case where, when the driver applies the sudden braking, that is, when the driver rapidly depresses the brake pedal 22, the driver assistance functions such as an anti-brake lock system (ABS) is activated, and thus a braking force corresponding to the depression amount of the brake pedal 22 cannot be obtained.

In other words, even when the driver depresses the brake pedal 22 rapidly, such braking may not result in sudden braking in terms of the vehicle behavior. As described above, there is a case where, when the driver assistance function intervenes on the operation line from the input as the operation amount to the output as the vehicle operation, the output and the input are out of balance. In other words, the vehicle 100 outputs acceleration, turning attitude, and braking amount that do not correspond to the operation amounts of the accelerator pedal 21, the steering wheel 20, and the brake pedal 22, by executing the driver assistance function.

Therefore, in the driver assistance system according to the present embodiment, for example, whether the noted action occurs is determined based on the actual operation amount of the driver, instead of the vehicle behavior, with respect to the noted action (sharp steering, sudden acceleration, sudden braking) related to the operation of the driver.

For example, when the brake pedal 22 is immediately deeply depressed, the driver assistance function may be activated and the sudden brake may not be applied to the vehicle 100. Even in such a case, the noted action determination unit 84 counts up the noted action “sudden braking” based on the operation amount of the brake pedal 22 detected by the brake position sensor 22A. It is possible to grasp the driving habits of each registered driver by performing such a determination.

Also, captured images are used for some of the noted actions. For example, the noted action determination unit 84 determines whether the driver looks aside based on the facial image recognition of the driver by the interior image recognition unit 72.

The noted action table also records the number of occurrences of each noted action item and its activation history. The activation history includes the date and time when and the location where the noted action occurs. The noted action determination unit 84 acquires the date and time data from the clock 37 (see FIG. 6). Further, the noted action determination unit 84 also acquires the location data from the self-position estimator 36. For example, the names of the facility, intersection, etc. closest to the latitude and longitude of the vehicle 100 when the noted action occurs are recorded in the driver assistance function recording table.

### Driver Registration

The driver information registration unit 82 can register the driver information of the vehicle 100. For example, new driver registration and setting changes can be performed from the center display 40 that is a touch panel.

For example, the driver information registration unit 82 stores the driver's name, account name, and password input by the registered driver in the driving information storage unit 80. Further, the driver information registration unit 82 stores the face image of the registered driver captured by the interior camera 51 in the driving information storage unit 80.

Face image data is utilized as an assistance function for new registration. For example, when the driver gets on the vehicle 100 and turns on a start button, the interior camera 51 is activated and captures a face image of the driver. The start button is, for example, a button for activating the control system of the vehicle 100.

The captured face image is recognized through the facial recognition by the interior image recognition unit 72. For example, image recognition is performed using a neural network such as the above-described CNN. When the interior image recognition unit 72 obtains the recognition result that the recognized face is different from the face of any of the registered drivers, that is, the face of a new registrant, the driver information registration unit 82 requests the new driver for making registration of the driver information.

For example, the driver information registration unit 82 causes the center display 40 to display the profile screen exemplified in FIG. 7 via the display control unit 92 of the AV-ECU 90. Also, a request message such as “please make a registration for a new driver” may be displayed on this profile screen. This profile screen can be displayed not only when the interior image recognition unit 72 recognizes the new driver, but also when the driver operates the center display 40.

The profile screen displays images of a registrant button 206 for selecting the existing registrant and a new registration button 208 for making registration of a new driver. In addition, the profile screen displays a guest button 204, a home button 200, and a return button 202. These buttons are selected when driver registration is unnecessary.

When the new registration button 208 is turned on, a profile of a new driver is created. For example, the interior camera 51 captures the face image of the new registrant. The face image is recognized by the interior image recognition unit 72, and the face image is registered.

FIG. 8 exemplifies the driver profile screen. Images of a driver face image 210, a driver name 212, a driver basic information tab 214, a driver assistance function information tab 216, and a driving diagnosis tab 218 are displayed on this screen. For example, when the driver basic information tab 214 is selected, the name, age, etc. of the registrant can be registered. Also, the identification code of the mobile terminal owned by the registrant is registered. Further, as profile information, for example, the position and height of the driver's seat, the angle of the seat back, and the like are registered.

FIG. 8 exemplifies the screen of the center display 40 when the driver assistance function information tab 216 is selected. In the driver assistance function information tab 216, various setting items are selected for each of a plurality of the driver assistance functions. The driver assistance function as a setting target can be switched by operating a return button 202 and a forward button 203. For example, in FIG. 8, pre-crash safety is displayed as a driver assistance function.

Furthermore, setting items for pre-crash safety include function on-off, the presence or absence of the notification, a buzzer volume, a detection sensitivity, and on-off of the personalization function. For example, among these setting items, the presence or absence of the notification and the buzzer volume are exemplified as the information provision type setting items. Further, the detection sensitivity is exemplified as the intervention operation type setting item because the timing at which the intervention operation command is transmitted from the ADAS-ECU 70 is changed.

In FIG. 8, initial values of the setting items are indicated by hatching. At the time of new registration, the driver can set the set values of the setting items to arbitrary values. In particular, at the time of new registration, the driver can set whether to use the personalization function for each driver assistance function, whereby the driver can select between the driver assistance function for which personalization is desired and the driver assistance function for which personalization is not desired.

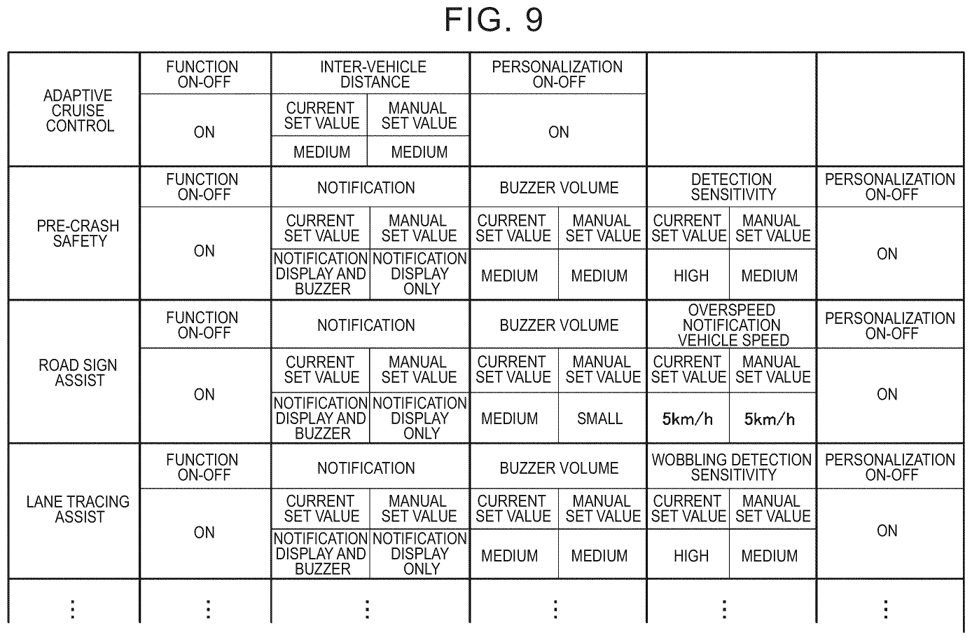

When settings for various driver assistance functions are completed, the setting information is stored in the driving information storage unit 80 in a format such as a driver assistance information setting table exemplified in FIG. 9. Among the setting items, manual set values and current set values may be recorded for setting items other than function on-off and personalization function on-off.

The manual set values refer to set values selected by the driver on the driver assistance function setting screen (FIG. 8). In other words, the manual set values represent the set values based on driver preferences. When the set value is not selected by the driver, the initial value becomes the manual set value. A value different from the manual set value can become the current set value by enabling the personalization function. As will be described later, the manual set values are referenced when the recommended values obtained by the personalization function are sorted into the approval type and the automatic change type.

### OTA Center Server

With reference to FIG. 1, the OTA center server 150 can transmit update programs for software and firmware installed in various ECUs of the vehicle 100 by wireless communication (over-the-air).

The OTA center server 150 wirelessly communicates with the vehicle 100, communicates with the I/F-ECU 112 (see FIG. 6) of the vehicle 100, and transmits and receives signals to and from various ECUs of the vehicle 100. For example, the OTA center server 150 is installed at a development center for the vehicle 100 or the like.

The OTA center server 150 is composed of a computer, for example, and includes a hardware configuration as exemplified in FIG. 5. The microcomputer of the OTA center server 150 executes the program stored in the memory, whereby the functional blocks exemplified in FIG. 1 are configured in the OTA center server 150. That is, the OTA center server 150 includes a driving diagnostic unit 151, a recommended value calculation unit 152, and a driving history storage unit 153.

The program may be stored in a non-transitory computer-readable storage medium such as a digital versatile disc (DVD), instead of storing the program in the memory, and the microcomputer may read and execute the program. Various functional blocks exemplified in FIG. 1 are configured in the OTA center server 150 by such means as well.

The driving history data of the vehicle 100 is transmitted to the driving diagnostic unit 151 via the OF-ECU 112 (see FIG. 6). The driving history data is data stored in the driving information storage unit 80 of the ADAS-ECU 70, and is organized for each registered driver as described above. As described above, the driving history data can also be called driving-related information, and the information includes information recorded in the driver assistance function recording table (see FIG. 10) and the noted action table (see FIG. 11).

The driving diagnostic unit 151 performs driving diagnosis based on the received driving history data and past driving history data stored in the driving history storage unit 153. For example, in the driving diagnosis, driving ability is evaluated for each classification such as handling, acceleration, or deceleration. For example, the driving ability is evaluated by score based on the number of noted actions and the number of times the driver assistance function is executed. For example, the driving diagnostic unit 151 obtains deduction points for the item of handling based on the number of times of sharp steering and the number of times that lane tracing assist is activated.

The recommended value calculation unit 152 calculates a recommended value of the driver assistance function for each registered driver based on the driver related information including the driving history. For example, as the number of noted actions related to the braking operation and the number of times that the driver assistance function related to braking operation is activated increase, the detection sensitivity of the driver assistance function related to the braking operation (for example, pre-crash safety) has a higher value as the recommended value. The calculated recommended value is transmitted to the personalization setting unit 81 of the ADAS-ECU 70 via the OF-ECU 112 of the vehicle 100.

### Personalization

The personalization setting unit 81 personalizes various driver assistance functions based on the recommended values of the driver assistance functions transmitted from the OTA center server 150. As described above, personalization is a proposal for setting changes from the driver assistance system side, and is different from customization in which the driver sets preferences.

The personalization is classified into the approval type and the automatic change type. In the approval type, the approval of the driver is required when the current set value is changed to the recommended value. In the automatic change type, the current set value is automatically changed to the recommended value without the approval of the driver.

### Approval Necessity Determination Flow

FIG. 12 exemplifies an approval necessity determination flow for determining whether the recommended value transmitted from the OTA center server 150 to the vehicle 100 is the approval type or the automatic change type for each setting item. This flow is executed by the personalization setting unit 81. Also, this flow is started when the recommended value is received from the OTA center server 150.

The personalization setting unit 81 extracts registered driver information corresponding to the initial value (m=1) of a driver counter m for the registered drivers stored in the driving information storage unit 80 (S10). Next, the personalization setting unit 81 extracts the driver assistance function to be personalized (personalized driver assistance function) (S12) with reference to the driver assistance function setting table (FIG. 9) related to the registered driver of the counter m.

Further, the personalization setting unit 81 extracts driver assistance function information corresponding to the initial value (n=1) of a driver assistance function counter n (S14). Then, the personalization setting unit 81 extracts the setting item of which the recommended value is different from the current set value among various setting items of the driver assistance function of the counter n=1 (S16). For example, when the current set value of the buzzer volume is “medium” and the recommended value is “small”, the setting item “buzzer volume” is extracted.

Next, the personalization setting unit 81 extracts the setting item information for a counter k=1 (S18). Then, the personalization setting unit 81 determines whether automatic change of the setting item of the counter k is disallowed legally (S20). For example, in the driving information storage unit 80, identification information indicating whether automatic change is legally prohibited is registered for each setting item. The personalization setting unit 81 refers to the registration information and makes a determination in step S20.

For example, with respect to the pre-crash safety setting item “notification”, when a consent of the driver is legally required, such as when the buzzer setting is changed from on to off, the personalization setting unit 81 sorts the recommended value of the setting item into the approval type (S32).

In step S20, when automatic change of the setting item of the counter k is allowed legally, the personalization setting unit 81 determines whether the similar change has been made during the previous trip (S22).

The trip denotes to a period from when a vehicle control system of the vehicle 100 is turned on until the vehicle control system is turned off. The driving information storage unit 80 stores past driving histories for each registered driver. Further, the driving information storage unit 80 also stores the change history of set values in past trips.

For example, when the set value is automatically changed by the personalization function, the set value is changed only for one trip, and is returned to the manual set value at the start of the next trip. The personalization setting unit 81 determines whether the current recommended value has also been proposed during the previous trip with reference to the change history of the set value (S22). When the current recommended value has also been proposed during the previous trip, the personalization setting unit 81 sorts this recommended value into the approval type (S32).

When the current recommended value has not been proposed at the time of the previous trip, the personalization setting unit 81 determines whether an assistance intensity of the driver assistance function of the counter n is lowered by changing the setting from the current set value to the recommended value (S24).

The lowered assistance intensity is that, in other words, a range of assistance by the driver assistance function is narrowed. For example, when the current set value of the setting item “detection sensitivity” of the pre-crash safety is “high” and the recommended value is “medium”, the assistance intensity is lowered. Further, when the current set value of the setting item “inter-vehicle distance” of the adaptive cruise control is “medium” and the recommended value is “short”, the assistance intensity is lowered.

The personalization setting unit 81 sorts the recommended value into the automatic change type when the recommended value raises the assistance intensity more than the currently set value (S30). On the other hand, when the recommended value lowers the assistance intensity from the current set value, the personalization setting unit 81 determines whether the assistance intensity of the driver assistance function of the counter n is lowered by changing the setting from the manual set value to the recommended value (S26).

The manual set value can be said to be a set value that the driver prefers. When the assistance intensity is lowered compared to the drive assistance based on the set value that the driver prefers, the driver may feel uncomfortable. When the assistance intensity is lowered based on the recommended value than that of the manual set value, the personalization setting unit 81 sorts the recommended value into the approval type (S32).

On the other hand, when the assistance intensity is raised based on the recommended value than that of the manual set value, the personalization setting unit 81 determines whether the setting item to which the recommended value is set is the intervention operation type (S28). For example, with reference to FIG. 9, the setting item “detection sensitivity” of the pre-crash safety is the intervention operation type because the start timing of an intervention braking operation based on the function differs depending on the set value. On the other hand, the setting item “buzzer volume” is not the intervention operation type but is the information provision type, because this function does not pass through the powertrain-chassis ECU 18 (see FIG. 6). For example, classification information as to whether each setting item is the intervention operation type or the information provision type is stored in the driving information storage unit 80.

When the setting item of the counter k is not the intervention operation type, the personalization setting unit 81 sorts the recommended value related to that setting item into the automatic change type (S30). On the other hand, when the setting item of the counter k is the intervention operation type, the personalization setting unit 81 sorts the recommended value with respect to that setting item into the approval type (S32).

Furthermore, the personalization setting unit 81 determines whether the setting item counter k is the final value k_end (S34). When the setting item counter k does not reach the final value k_end, the personalization setting unit 81 increments the counter k (S40) and returns to step S20.

When the setting item counter k has reached the final value k_end, the personalization setting unit 81 determines whether the personalized driver assistance function counter n has reached a final value n_end (S36). When the counter n does not reach the final value n_end, the personalization setting unit 81 increments the counter n (S42) and returns to step S16.

When the personalized driver assistance function counter n has reached the final value n_end, the personalization setting unit 81 determines whether the registered driver counter m has reached the final value m_end (S38). When the registered driver counter m does not reach the final value m_end, the personalization setting unit 81 increments the counter m (S44) and returns to step S12. When the registered driver counter m has reached the final value m_end, the flow in FIG. 12 is completed.

When the flow in FIG. 12 is completed, the personalization setting unit 81 extracts the setting item corresponding to the registered driver who is recognized by the interior camera 51 from among the setting items sorted into the automatic change type, for example, and changes the set value from the current set value to the recommended value.

The content of this change can be reported to the driver on a report screen as exemplified in FIG. 13. The report screen is displayed on the center display 40 by the display control unit 92 (see FIG. 6), for example, when the shift lever of the vehicle is in the P range.

In this report screen, images of an OK button 230 and a detail button 232 are displayed in addition to a message indicating that the set value is changed. When the OK button 230 is turned on, the display control unit 92 switches the display from the report screen to a predetermined home screen.

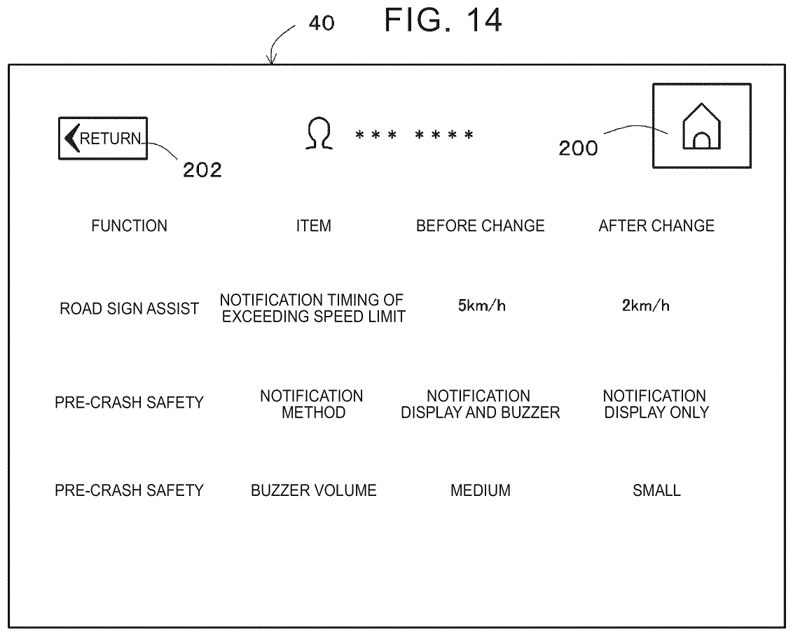

Further, when the detail button 232 is turned on, the display control unit 92 switches the display to the detailed report screen exemplified in FIG. 14. This screen displays the driver assistance function and setting items that are automatically changed and the set values before and after the change.

Further, after the flow in FIG. 12 is completed, the approval by the driver is required for the setting item of the approval type. The personalization setting unit 81 extracts the setting item corresponding to the registered driver who is recognized by the interior camera 51 from among the setting items sorted into the approval type, for example.

Then, when the vehicle 100 is stopped while waiting for a signal or the like, the display control unit 92 displays an approval screen as exemplified in FIG. 15 on the center display 40. Images of an OK button 240 and a detail button 242 are displayed on the approval screen.

The OK button 240 is a button for permitting the change to the approval type recommended values all at once. Note that the change to the recommended value is limited to the current trip, and the manual set values are set on the next trip.

When the detail button 242 is turned on, the display control unit 92 displays an approval detail screen exemplified in FIG. 16. In addition to the driver assistance function to be changed and its setting item, the values before and after the change of the set value are displayed on this screen. Images of limited approval buttons 244A, 245A, 246A, comprehensive approval buttons 244B, 245B, 246B, and disapproval buttons 244C, 245C, 246C are displayed on the approval detail screen corresponding to such changes. The limited approval buttons 244A, 245A, 246A are buttons for approving changes limited to the current trip. The comprehensive approval buttons 244B, 245B, 246B are buttons for approving changes over subsequent trips.

As described above, in the present embodiment, the setting items of the automatic change type are changed without the approval of the driver, whereby it is possible to save time and effort for the approval operation. Further, changes in the set values that may cause discomfort to the driver are set to an approval type, whereby it is possible to avoid causing discomfort associated with the setting changes.

What is claimed is:

1. A driver assistance system for a vehicle, wherein:
a plurality of driver assistance functions is executable with respect to the vehicle, a plurality of setting items is set for each of the driver assistance functions, and a set value is set for each of the setting items; and
the driver assistance system includes
a driver information registration unit that is able to register driver information, a recommended value calculation unit that obtains a recommended value for the set value based on driving-related information of a driver including a driving history, and
a personalization setting unit that requests a new driver for setting whether to use a personalization function that is able to change the set value of the driver assistance function to the recommended value for each of the driver assistance functions when the new driver is registered in the driver information registration unit.

2. The driver assistance system according to claim 1, wherein the personalization setting unit determines whether the setting item to which the recommended value is set is an intervention operation type when making an approval necessity determination for sorting a plurality of the recommended values into an approval type recommended value requiring an approval of the driver and an automatic change type recommended value not requiring the approval of the driver.

3. The driver assistance system according to claim 2, wherein the personalization setting unit determines whether a change to the recommended value reduces an intensity of driving assistance when making the approval necessity determination.

4. The driver assistance system according to claim 1, further comprising:
an imaging device including a driver's seat in a field of view; and
an image recognition unit that recognizes a face of the driver who is seated in the driver's seat based on an image captured by the imaging device, wherein when the image recognition unit recognizes the new driver, the driver information registration unit requests the new driver for registering the driver information.

5. The driver assistance system according to claim 4, wherein the driver information registration unit registers an image of the face recognized by the image recognition unit as the driver information.
